(19) United States
(12) Patent Application Publication
(10) Pub. No.: US 2003/0144386 A1
(43) Pub. Date: Jul. 31, 2003

(54) Mixtures of hydrogel-forming polymers and building materials

(75) Inventors: Joachim Pakusch, Speyer (DE); Hans-Jurgen Denu, Friedelsheim (DE); Ekkehard Jahns, Weinheim (DE); Rudiger Funk, Niedernhausen (DE); Ulrike Hoss, Kriftel (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/327,936

(22) Filed: Dec. 26, 2002

(30) Foreign Application Priority Data
Jan. 18, 2002 (DE) 10202039.6

(51) Int. Cl. C08K 3/00

(52) U.S. Cl. 524/5; 524/3; 525/329.7

(57) ABSTRACT

Mixtures of finely divided solid hydrogel-forming polymers and of hydraulically setting building materials, wherein not more than 2% by weight of said finely divided hydrogel-forming polymers are more than 200 μm in particle size. The finely divided solid hydrogel-forming polymers used are in particular crosslinked polymers having acid groups.

### DESCRIPTION

The present invention relates to mixtures of finely divided solid hydrogel-forming polymers and of hydraulically setting building materials, wherein not more than 2% by weight of said finely divided hydrogel-forming polymers are more than 200 μm in particle size.

The present invention further relates to a process for preparing the mixtures of the invention and to the use of finely divided solid hydrogel-forming polymers as aggregates for hydraulically setting building materials.

The addition of hydrogel-forming polymers, also known as superabsorbent polymers (SAPs), to hydraulically setting building materials such as mortar, cement or gypsum is known. For instance, DE-A 19539250 describes mixtures of superabsorbent materials and water-soluble polyalkylene oxides that are used as binding additives for cement preparations. In EP-B 530768, furthermore, building materials are modified by means of mixtures of at least 65% by weight of a water-soluble cellulose ether with polyacrylamide and up to 20% by weight of a superabsorbent polymer.

EP-A 448717 relates to cement additives prepared by specific crosslinking of water-soluble main chains. These main chains preferably have side chains containing sulfonic acid or polyethylene oxide. Such additives primarily have a dispersing (fluidizing) effect, there is no mention of increased compressive strength.

EP-A 338739 discloses a production method wherein superabsorbent polymers which have been preswollen with water are added as aggregates to mortar or concretes which are then for example capable of forming defined voids after drying. JP-A 63011558 discloses modifying concrete with a superabsorbent polymer which has a water absorption of more than 400 g of water per gram of SAP and also a particle size of less than 50 μm.

Hydraulically setting building materials need to be supplied with free water for a sufficiently long period for the hydration reaction. Particularly products which are employed in thin layers atop absorbent grounds are always likely to dry out prematurely and to hydrate incompletely. The consequences include particularly insufficient initial strength but also low final strength. It is further always important to improve the compressive strength and the flexural tensile strength of building materials by addition of suitable assistant materials.

It is an object of the present invention to provide improved hydraulically setting building materials which meet the aforementioned requirements in an advantageous manner and are notable for high strength in particular.

We have found that this object is achieved by novel improved mixtures of finely divided solid hydrogel-forming polymers and of hydraulically setting building materials, wherein not more than 2% by weight of said finely divided hydrogel-forming polymers are more than 200 μm in particle size.

The present invention also provides an improved process for preparing the mixtures of the invention. The present invention further extends to the use of the mixtures of the invention as aggregates for hydraulically setting building materials.

The mixtures of the invention, as well as hydraulically setting building materials, include finely divided solid hydrogel-forming polymers in such an amount that their fraction is from 0.01 to 5% by weight, preferably from 0.05 to 2% by weight and more preferably from 0.1 to 1% by weight, of said hydraulically setting building material.

The finely divided solid hydrogel-forming polymers used in the mixtures of the invention have not more than 2% by weight of particles more than 200 μm in diameter. The hydrogel-forming polymers preferably have not more than 1.5% by weight of particles more than 200 μm in diameter.

Hydrogel forming polymers are in particular polymers of (co)polymerized hydrophilic monomers, graft (co)polymers of one or more hydrophilic monomers on a suitable grafting base, crosslinked cellulose or starch ethers, crosslinked carboxymethylcellulose, partially crosslinked polyalkylene oxide or natural products that swell in aqueous fluids, for example guar derivatives, alginates and carrageenans.

Suitable grafting bases can be of natural or synthetic origin. Examples are starch, cellulose or cellulose derivatives and also other polysaccharides and oligosaccharides, polyvinyl alcohol, polyalkylene oxides, especially polyethylene oxides and polypropylene oxides, polyamines, polyamides and also hydrophilic polyesters. Suitable polyalkylene oxides have for example the formula

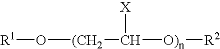

where

R¹ and R² are independently hydrogen, alkyl, alkenyl or aryl,

X is hydrogen or methyl and

n is an integer from 1 to 10 000.

R¹ and R² are each preferably hydrogen, (C₁-C₄)-alkyl, (C₂-C₆)-alkenyl or phenyl.

Preferred hydrogel forming polymers are crosslinked polymers having acid groups which are predominantly in the form of their salts, generally alkali metal or ammonium salts. Such polymers swell particularly strongly on contact with aqueous fluids to form gels.

Preference is given to polymers which are obtained by crosslinking polymerization or copolymerization of acid-functional monoethylenically unsaturated monomers or their salts. It is further possible to (co)polymerize these monomers without crosslinker and to crosslink them subsequently.

Examples of such monomers bearing acid groups are monoethylenically unsaturated C₃- to C₂₅-carboxylic acids or anhydrides such as acrylic acid, methacrylic acid, ethacrylic acid, α-chloroacrylic acid, crotonic acid, maleic acid, maleic anhydride, itaconic acid, citraconic acid, mesaconic acid, glutaconic acid, aconitic acid and fumaric acid. It is also possible to use monoethylenically unsaturated sulfonic or phosphonic acids, for example vinylsulfonic acid, allylsulfonic acid, sulfoethyl acrylate, sulfo methacrylate, sulfopropyl acrylate, sulfopropyl methacrylate, 2-hydroxy-3-acryloyloxy-propylsulfonic acid, 2-hydroxy-3-methacryloyloxypropylsulfonic acid, vinylphosphonic acid, allylphosphonic acid, styrene-sulfonic acid and 2-acrylamido-2-methylpropanesulfonic acid. The monomers may be used alone or mixed.

Preferred monomers used are acrylic acid, methacrylic acid, vinylsulfonic acid, acrylamidopropanesulfonic acid or mixtures thereof, for example mixtures of acrylic acid and methacrylic acid, mixtures of acrylic acid and acrylamidopropanesulfonic acid or mixtures of acrylic acid and vinylsulfonic acid. Acrylic acid is particularly preferred as monomer.

To optimize properties, it can be sensible to use additional monoethylenically unsaturated compounds which do not bear an acid group but are copolymerizable with the monomers bearing acid groups. Such compounds include for example the amides and nitriles of monoethylenically unsaturated carboxylic acid, for example acrylamide, methacrylamide and N-vinylformamide, N-vinylacetamide, N-methyl-N-vinylacetamide, acrylonitrile and methacrylonitrile. Examples of further suitable compounds are vinyl esters of saturated C₁- to C₄-carboxylic acids such as vinyl formate, vinyl acetate or vinyl propionate, alkyl vinyl ethers having at least 2 carbon atoms in the alkyl group, for example ethyl vinyl ether or butyl vinyl ether, esters of monoethylenically unsaturated C₃- to C₆-carboxylic acids, for example esters of monohydric C₁- to C₁₈-alcohols and acrylic acid, methacrylic acid or maleic acid, monoesters of maleic acid, for example methyl hydrogen maleate, N-vinyllactams such as N-vinylpyrrolidone or N-vinylcaprolactam, acrylic and methacrylic esters of alkoxylated monohydric saturated alcohols, for example of alcohols having from 10 to 25 carbon atoms which have been reacted with from 2 to 200 mol of ethylene oxide and/or propylene oxide per mole of alcohol, and also monoacrylic esters and monomethacrylic esters of polyethylene glycol or polypropylene glycol, the molar masses (Mₙ) of the polyalkylene glycols being up to 2 000, for example. Further suitable monomers are styrene and alkyl-substituted styrenes such as ethylstyrene or tert-butylstyrene.

These monomers without acid groups may also be used in mixture with other monomers, for example mixtures of vinyl acetate and 2-hydroxyethyl acrylate in any proportion. These monomers without acid groups are added to the reaction mixture in amounts within the range from 0 to 50% by weight, preferably less than 20% by weight.

Preference is given to crosslinked polymers of monoethylenically unsaturated monomers which bear acid groups and which are optionally converted into their alkali metal or ammonium salts before or after polymerization and of 0-40% by weight, based on their total weight, of monoethylenically unsaturated monomers which do not bear acid groups.

Preference is given to crosslinked polymers of monoethylenically unsaturated C₃- to C₁₂-carboxylic acids and/or their alkali metal or ammonium salts. Preference is given in particular to crosslinked polyacrylic acids where 5-30 mol %, preferably 5-20 mol % and particularly preferably 5-10 mol % of their acid groups, based on the monomers containing acid groups, are present as alkali metal or ammonium salts.

Possible crosslinkers include compounds containing at least two ethylenically unsaturated double bonds. Examples of compounds of this type are N,N′-methylenebisacrylamide, polyethylene glycol diacrylates and polyethylene glycol dimethacrylates each derived from polyethylene glycols having a molecular weight of from 106 to 8500, preferably from 400 to 2000, trimethylolpropane triacrylate, trimethylolpropane trimethacrylate, ethylene glycol diacrylate, ethylene glycol dimethacrylate, propylene glycol diacrylate, propylene glycol dimethacrylate, butanediol diacrylate, butanediol dimethacrylate, hexanediol diacrylate, hexanediol dimethacrylate, allyl methacrylate, diacrylates and dimethacrylates of block copolymers of ethylene oxide and propylene oxide, polyhydric alcohols, such as glycerol or pentaerythritol, doubly or more highly esterified with acrylic acid or methacrylic acid, triallylamine, dialkyldiallylammonium halides such as dimethyldiallylammonium chloride and diethyldiallylammonium chloride, tetraallylethylenediamine, divinylbenzene, diallyl phthalate, polyethylene glycol divinyl ethers of polyethylene glycols having a molecular weight of from 106 to 4 000, trimethylolpropane diallyl ether, butanediol divinyl ether, pentaerythritol triallyl ether, reaction products of 1 mol of ethylene glycol diglycidyl ether or polyethylene glycol diglycidyl ether with 2 mol of pentaerythritol triallyl ether or allyl alcohol, and/or divinylethyleneurea. Preference is given to using water-soluble crosslinkers, for example N,N′-methylenebisacrylamide, polyethylene glycol diacrylates and polyethylene glycol dimethacrylates derived from addition products of from 2 to 400 mol of ethylene oxide with 1 mol of a diol or polyol, vinyl ethers of addition products of from 2 to 400 mol of ethylene oxide with 1 mol of a diol or polyol, ethylene glycol diacrylate, ethylene glycol dimethacrylate or triacrylates and trimethacrylates of addition products of from 6 to 20 mol of ethylene oxide with 1 mol of glycerol, pentaerythritol triallyl ether and/or divinylurea.

Possible crosslinkers also include compounds containing at least one polymerizable ethylenically unsaturated group and at least one further functional group. The functional group of these crosslinkers has to be capable of reacting with the functional groups, essentially the acid groups, of the monomers. Suitable functional groups include for example hydroxyl, amino, epoxy and aziridino groups. Useful are for example hydroxyalkyl esters of the abovementioned monoethylenically unsaturated carboxylic acids, e.g., 2-hydroxyethyl acrylate, hydroxypropyl acrylate, hydroxybutyl acrylate, hydroxyethyl methacrylate, hydroxypropyl methacrylate and hydroxybutyl methacrylate, allylpiperidinium bromide, N-vinylimidazoles, for example N-vinylimidazole, 1-vinyl-2-methylimidazole and N-vinylimidazolines such as N-vinylimidazoline, 1-vinyl-2-methylimidazoline, 1-vinyl-2-ethylimidazoline or 1-vinyl-2-propylimidazoline, which can be used in the form of the free bases, in quaternized form or as salt in the polymerization. It is also possible to use dialkylaminoethyl acrylate and dimethylaminoethyl methacrylate, diethylaminoethyl acrylate and diethylaminoethyl methacrylate. The basic esters are preferably used in quaternized form or as salt. It is also possible to use glycidyl (meth)acrylate, for example.

Useful crosslinkers further include compounds containing at least two functional groups capable of reacting with the functional groups, essentially the acid groups, of the monomers. Suitable functional groups were already mentioned above, i.e., hydroxyl, amino, epoxy, isocyanato, ester, amido and aziridino groups. Examples of such crosslinkers are ethylene glycol, diethylene glycol, triethylene glycol, tetraethylene glycol, polyethylene glycol, glycerol, polyglycerol, triethanolamine, propylene glycol, polypropylene glycol, block copolymers of ethylene oxide and propylene oxide, ethanolamine, sorbitan fatty acid esters, ethoxylated sorbitan fatty acid esters, trimethylolpropane, pentaerythritol, 1,3-butanediol, 1,4-butanediol, polyvinyl alcohol, sorbitol, starch, polyglycidyl ethers such as ethylene glycol diglycidyl ether, polyethylene glycol diglycidyl ether, glycerol diglycidyl ether, glycerol polyglycidyl ether, diglycerol polyglycidyl ether, polyglycerol polyglycidyl ether, sorbitol polyglycidyl ether, pentaerythritol polyglycidyl ether, propylene glycol diglycidyl ether and polypropylene glycol diglycidyl ether, polyaziridine compounds such as 2,2-bishydroxymethylbutanol tris[3-(1-aziridinyl)propionate], 1,6-hexamethylenediethyleneurea, diphenylmethanebis-4,4′-N,N′-diethyleneurea, haloepoxy compounds such as epichlorohydrin and o-methylepifluorohydrin, polyisocyanates such as 2,4-toluylene diisocyanate and hexamethylene diisocyanate, alkylene carbonates such as 1,3-dioxolan-2-one and 4-methyl-1,3-dioxolan-2-one, also bisoxazolines and oxazolidones, polyamidoamines and also their reaction products with epichlorohydrin, also polyquaternary amines such as condensation products of dimethylamine with epichlorohydrin, homo- and copolymers of diallyldimethylammonium chloride and also homo- and copolymers of dimethylamincethyl (meth)acrylate which are optionally quaternized with, for example, methyl chloride.

Useful crosslinkers further include multivalent metal ions capable of forming ionic crosslinks. Examples of such crosslinkers are magnesium, calcium, barium and aluminum ions. These crosslinkers are used for example as hydroxides, carbonates or bicarbonates. Useful crosslinkers further include multifunctional bases likewise capable of forming ionic crosslinks, for example polyamines or their quaternized salts. Examples of polyamines are ethylenediamine, diethylenetriamine, triethylenetetramine, tetraethylenepentamine, pentaethylenehexamine and polyethyleneimines and also polyamines having molar masses in each case of up to 4 000 000.

The crosslinkers are present in the reaction mixture for example from 0.001 to 20% and preferably from 0.01 to 14% by weight.

The polymerization is initiated in the generally customary manner, by means of an initiator. But the polymerization may also be initiated by electron beams acting on the polymerizable aqueous mixture. However, the polymerization may also be initiated in the absence of initiators of the abovementioned kind, by the action of high energy radiation in the presence of photoinitiators. Useful polymerization initiators include all compounds which decompose into free radicals under the polymerization conditions, for example peroxides, hydroperoxides, hydrogen peroxides, persulfates, azo compounds and redox catalysts. The use of water-soluble initiators is preferred. In some cases it is advantageous to use mixtures of different polymerization initiators, for example mixtures of hydrogen peroxide and sodium peroxodisulfate or potassium peroxodisulfate. Mixtures of hydrogen peroxide and sodium peroxodisulfate may be used in any proportion. Examples of suitable organic peroxides are acetylacetone peroxide, methyl ethyl ketone peroxide, tert-butyl hydroperoxide, cumene hydroperoxide, tert-amyl perpivalate, tert-butyl perpivalate, tert-butyl perneohexanoate, tert-butyl perisobutyrate, tert-butyl per-2-ethylhexanoate, tert-butyl perisononanoate, tert-butyl permaleate, tert-butyl perbenzoate, di(2-ethylhexyl) peroxydicarbonate, dicyclohexyl peroxydicarbonate, di(4-tert-butylcyclohexyl) peroxydicarbonate, dimyristyl peroxydicarbonate, diacetyl peroxydicarbonate, allyl peresters, cumyl peroxyneodecanoate, tert-butyl per-3,5,5-trimethylhexanoate, acetylcyclohexylsulfonyl peroxide, dilauryl peroxide, dibenzoyl peroxide and tert-amyl perneodecanoate. Particularly suitable polymerization initiators are water-soluble azo initiators, e.g.,

2,2′-azobis(2-amidinopropane) dihydrochloride,

2,2′-azobis(N,N′-dimethylene)isobutyramidine dihydrochloride,

2-(carbamoylazo)isobutyronitrile,

2,2′-azobis[2-(2′-imidazolin-2-yl)propane] dihydrochloride and

4,4′-azobis(4-cyanovaleric acid). The polymerization initiators mentioned are used in customary amounts, for example in amounts of from 0.01 to 5%, preferably from 0.05 to 2.0%, by weight, based on the monomers to be polymerized.

Useful initiators also include redox catalysts. In redox catalysts, the oxidizing component is at least one of the above-specified per compounds and the reducing component is for example ascorbic acid, glucose, sorbose, ammonium or alkali metal bisulfite, sulfite, thiosulfate, hyposulfite, pyrosulfite or sulfide, or a metal salt, such as iron(II) ions or sodium hydroxymethylsulfoxylate. The reducing component in the redox catalyst is preferably ascorbic acid or sodium sulfite. Based on the amount of monomers used in the polymerization, from 3 x 10-6 to 1 mol % may be used for the reducing component of the redox catalyst system and from 0.001 to 5.0 mol % for the oxidizing component of the redox catalyst, for example.

When the polymerization is initiated using high energy radiation, the initiator used is customarily a photoinitiator. Photoinitiators include for example α-splitters, H-abstracting systems or else azides. Examples of such initiators are benzophenone derivatives such as Michler's ketone, phenanthrene derivatives, fluorene derivatives, anthraquinone derivatives, thioxanthone derivatives, coumarin derivatives, benzoin ethers and derivatives thereof, azo compounds such as the abovementioned free-radical formers, substituted hexaarylbisimidazoles or acylphosphine oxides. Examples of azides are: 2-(N,N-dimethylamino)ethyl 4-azidocinnamate, 2-(N,N-dimethyl-amino)ethyl 4-azidonaphthyl ketone, 2-(N,N-dimethylamino)ethyl 4-azidobenzoate, 5-azido-1-naphthyl 2′-(N,N-dimethylamino)ethyl sulfone, N-(4-sulfonylazidophenyl)maleimide, N-acetyl-4-sulfonylazidoaniline, 4-sulfonylazidoaniline, 4-azidoaniline, 4-azidophenacyl bromide, p-azidobenzoic acid, 2,6-bis(p-azido-benzylidene)cyclohexanone and 2,6-bis(p-azidobenzylidene)-4-methylcyclohexanone. Photoinitiators, if used, are-customarily used in amounts of from 0.01 to 5% of the weight of the monomers to be polymerized.

The crosslinked polymers are preferably used in partially neutralized form. The degree of neutralization is preferably in the range from 5 to 60 mol %, more preferably in the range from 10 to 40 mol %, particularly preferably in the range from 20 to 30 mol %, based on the monomers containing acid groups. Useful neutralizing agents include alkali metal bases or ammonia/amines. Preference is given to the use of aqueous sodium hydroxide solution, aqueous potassium hydroxide solution or lithium hydroxide. However, neutralization may also be effected using sodium carbonate, sodium bicarbonate, potassium carbonate or potassium bicarbonate or other carbonates or bicarbonates or ammonia. Moreover primary, secondary and tertiary amines may be used.

Alternatively, the degree of neutralization can be set before, during or after the polymerization in all apparatuses suitable for this purpose. The neutralization can be effected for example directly in a kneader used for the polymerization.

Industrial processes useful for making these products include all processes which are customarily used to make superabsorbers, as described for example in Chapter 3 of “Modern Superabsorbent Polymer Technology”, F. L. Buchholz and A. T. Graham, Wiley-VCH, 1998.

Polymerization in aqueous solution is preferably conducted as a gel polymerization. It involves 10-70% strength by weight aqueous solutions of the monomers and optionally of a suitable grafting base being polymerized in the presence of a free-radical initiator by utilizing the Trommsdorff-Norrish effect.

The polymerization reaction may be carried out at from 0 to 150° C., preferably at from 10 to 100° C., not only at atmospheric pressure but also at superatmospheric or reduced pressure. As is customary, the polymerization may also be conducted in a protective gas atmosphere, preferably under nitrogen.

By subsequently heating the polymer gels at from 50 to 130° C., preferably at from 70 to 100° C., for several hours, the performance characteristics of the polymers can be further improved.

Preference is given to hydrogel forming polymers which have been surface-postcrosslinked. Surface postcrosslinking may be carried out in a conventional manner using dried, ground and classified polymer particles.

To effect surface postcrosslinking, compounds capable of reacting with the functional groups of the polymers by crosslinking are applied to the surface of the hydrogel particles, preferably in the form of an aqueous solution. The aqueous solution may contain water-miscible organic solvents. Suitable solvents are alcohols such as methanol, ethanol, i-propanol, ethylene glycol, propylene glycol or acetone.

The subsequent crosslinking reacts polymers which have been prepared by the polymerization of the abovementioned monoethylenically unsaturated acids and optionally monoethylenically unsaturated comonomers and which have a molecular weight of greater than 5 000, preferably greater than 50 000, with compounds which have at least two groups reactive toward acid groups. This reaction can take place at room temperature or else at elevated temperatures up to 220° C.

Suitable postcrosslinkers include for example

di- or polyglycidyl compounds such as diglycidyl phosphonates or ethylene glycol diglycidyl ether, bischlorohydrin ethers of polyalkylene glycols,

alkoxysilyl compounds,

polyaziridines, aziridine compounds based on polyethers or substituted hydrocarbons, for example bis-N-aziridinomethane,

polyamines or polyamidoamines and their reaction products with epichlorohydrin,

polyols such as ethylene glycol, 1,2-propanediol, 1,4-butanediol, glycerol, methyltriglycol, polyethylene glycols having an average molecular weight M_{w} of 200-10 000, di- and polyglycerol, pentaerythritol, sorbitol, the ethoxylates of these polyols and their esters with carboxylic acids or carbonic acid such as ethylene carbonate or propylene carbonate,

carbonic acid derivatives such as urea, thiourea, guanidine, dicyandiamide, 2-oxazolidinone and its derivatives, bisoxazoline, polyoxazolines, di- and polyisocyanates,

di- and poly-N-methylol compounds such as, for example, methylenebis(N-methylolmethacrylamide) or melamine-formaldehyde resins,

compounds having two or more blocked isocyanate groups such as, for example, trimethylhexamethylene diisocyanate blocked with 2,2,3,6-tetramethylpiperidin-4-one.

If necessary, acidic catalysts may be added, for example p-toluenesulfonic acid, phosphoric acid, boric acid or ammonium dihydrogenphosphate.

Particularly suitable postcrosslinkers are di- or polyglycidyl compounds such as ethylene glycol diglycidyl ether, the reaction products of polyamidoamines with epichlorohydrin and 2-oxazolidinone.

The crosslinker solution is preferably applied by spraying with a solution of the crosslinker in conventional reaction mixers or mixing and drying equipment such as Patterson-Kelly mixers, DRAIS turbulence mixers, Lodige mixers, screw mixers, plate mixers, fluidized bed mixers and Schugi Mix. The spraying of the crosslinker solution may be followed by a heat treatment step, preferably in a downstream dryer, at from 80 to 230° C., preferably 80-190° C., particularly preferably at from 100 to 160° C., for from 5 minutes to 6 hours, preferably from 10 minutes to 2 hours, particularly preferably from 10 minutes to 1 hour, during which not only cracking products but also solvent fractions can be removed. But the drying may also take place in the mixer itself, by heating the jacket or by blowing in a preheated carrier gas.

In a preferred embodiment of the invention, the hydrophilicity of the particle surface of the hydrogel forming polymer is additionally modified by formation of complexes. The formation of complexes on the outer shell of the hydrogel particles is effected by spraying with solutions of divalent or more highly valent metal salt solutions, and the metal cations can react with the acid groups of the polymer to form complexes. Examples of divalent or more highly valent metal cations are Mg²⁺, Ca²⁺, Al³⁺, Sc³⁺, Ti⁴⁺, Mn²⁺, Fe^{2+/3+}, Co²⁺, Ni²⁺, Cu^{+/2+}, Zn²⁺, Y³⁺, Zr⁴⁺, Ag⁺, La³⁺, Ce⁴⁺, Hf⁴⁺, and Au^{+/3+}, preferred metal cations are Mg²⁺, Ca²⁺, Al³⁺, Ti⁴⁺, Zr⁴⁺ and La³⁺, and particularly preferred metal cations are Al³⁺, Ti⁴⁺ and Zr⁴⁺. The metal cations may be used not only alone but also mixed with each other. Of the metal cations mentioned, all metal salts are suitable that possess adequate solubility in the solvent to be used. Of particular suitability are metal salts with weakly complexing anions such as for example chloride, nitrate and sulfate. Useful solvents for the metal salts include water, alcohols, DMF, DMSO and also mixtures thereof. Particular preference is given to water and water-alcohol mixtures such as for example water-methanol or water-1,2-propanediol.

The spraying of the metal salt solution onto the particles of the hydrogel forming polymer may be effected not only before but also after the surface postcrosslinking of the particles. In a particularly preferred process, the spraying of the metal salt solution takes place in the same step as the spraying with the crosslinker solution, the two solutions being sprayed separately in succession or simultaneously via two nozzles or the crosslinker and metal salt solutions may be sprayed conjointly through a single nozzle.

Optionally, the hydrogel forming polymers may be further modified by admixture of finely divided inorganic solids, for example silica, alumina, titanium dioxide and iron(II) oxide, to further augment the effects of the surface aftertreatment. Particular preference is given to the admixture of hydrophilic silica or of alumina having an average primary particle size of from 4 to 50 nm and a specific surface area of 50-450 m²/g. The admixture of finely divided inorganic solids preferably takes place after the surface modification through crosslinking/complexing, but may also be carried out before or during these surface modifications.

Preferred finely divided solid hydrogel-forming polymers for the mixtures of the invention are finely divided solid hydrogel-forming polymers which are characterized inter alia by an Absorbency Under Load (AUL) of more than 5 g/g, especially of more than 7 g/g and less than 100 g/g, especially less than 80 g/g, and a Centrifuge Retention Capacity (CRC) of more than 10 g/g, especially of more than 12 g/g and less than 100 g/g, especially less than 80 g/g. The exact performance of these test methods, ie the determination of the respective values of AUL and CRC, are described in the experimental part.

The mixtures of the invention further include hydraulic binders, for example lime, cement or gypsum, and also further, conventional aggregates such as sand, quartz flour or chalk. The mixtures of the invention may further include conventional building chemistry additives such as for example cellulose ethers, standardizers, hydration accelerants and hydration retardants, polymer dispersions or dispersion powders. Particularly good results are obtained with such mixtures as include cement or gypsum as hydraulically setting building materials.

The invention further provides a process for preparing mixtures which are advantageously obtainable by mixing said finely divided solid hydrogel-forming polymers with said hydraulically setting building materials, which comprises adding said finely divided solid hydrogel-forming polymers to the pulverulent building material prior to mixing with water. This can be effected in customary mixing apparatus of the building construction industry, for example in paddle mixers or else in other known forced mixing assemblies.

The invention further provides for the use of finely divided solid hydrogel-forming polymers having not more than 2% by weight of particles more than 200 μm in size as aggregates for hydraulically setting building materials, preferably based on cement, lime or gypsum.

The mixtures of the invention are notable inter alia for their ability to store water for a prolonged period and thereby possess not only a higher initial strength but also a higher final strength after 28 days under standard conditions. They are obtainable by an economically favorable process which is easy to carry out.

### EXPERIMENTAL PART

I. Test Methods

a) Centrifuge Retention Capacity (CRC)

This method measures the free swellability of the hydrogel in a teabag. 0.2000±0.0050 g of dried hydrogel (particle size fraction 106-850 μm) are weighed into a teabag 60 x 85 mm in size which is subsequently sealed. The teabag is placed for 30 minutes in an excess of 0.9% by weight sodium chloride solution (at least 0.83 1 of sodium chloride solution/l g of polymer powder). The teabag is then centrifuged for 3 minutes at 250 g. The amount of liquid is determined by weighing back the centrifuged teabag.

b) Absorbency Under Load (AUL) (0.7 psi)

The measuring cell for determining AUL 0.7 psi is a Plexiglass cylinder 60 mm in internal diameter and 50 mm in height. Adhesively attached to its underside is a stainless steel sieve bottom having a mesh size of 36 μm. The measuring cell further includes a plastic plate having a diameter of 59 mm and a weight which can be placed in the measuring cell together with the plastic plate. The plastic plate and the weight together weigh 1 345 g. AUL 0.7 psi is determined by determining the weight of the empty Plexiglass cylinder and of the plastic plate and recording it as W₀. 0.900±0.005 g of hydrogel forming polymer is then weighed into the Plexiglass cylinder and distributed very uniformly over the stainless steel sieve bottom. The plastic plate is then carefully placed in the Plexiglass cylinder, the entire unit is weighed and the weight is recorded as Wₐ. The weight is then placed on the plastic plate in the Plexiglass cylinder. A ceramic filter plate 120 mm in diameter and 0 in porosity is then placed in the middle of a Petri dish 200 mm in diameter and 30 mm in height and sufficient 0.9% by weight sodium chloride solution is introduced for the surface of the liquid to be level with the filter plate surface without the surface of the filter plate being wetted. A round filter paper 90 mm in diameter and <20 μm in pore size (S&S 589 Schwarzband from Schleicher & Schull) is subsequently placed on the ceramic plate. The Plexiglass cylinder containing hydrogel forming polymer is then placed with plastic plate and weight on top of the filter paper and left there for 60 minutes. At the end of this period, the complete unit is removed from the filter paper and the Petri dish and subsequently the weight is removed from the Plexiglass cylinder. The Plexiglass cylinder containing swollen hydrogel is weighed together with the plastic plate and the weight recorded as W_{b}.

AUL is calculated by the following equation:

AUL [g/g]=[W_{b}−Wₐ]/[Wₐ−W₀]

II. Conducted Experiments

The following superabsorbent polymers (SAPs) used are in accordance with the invention:

SAP 1 (Hysorb C 3746-1 from BASF Aktiengesellschaft) having a CRC of 15 g/g in 0.9% sodium chloride solution, an AUL (0.5 psi) of 8 g/g and less than 1.5% by weight of particles >200 μm in size

SAP 2 (Hysorb C 3746-5 from BASF Aktiengesellschaft) having a CRC of 25 g/g in 0.9% sodium chloride solution, an AUL (0.5 psi) of 18 g/g and less than 1% by weight of particles >200 μm in size

The following superabsorbent polymers (SAPs) used are comparative, not in accordance with the invention:

SAP 3* (Hysorb C 7015 from BASF Aktiengesellschaft) having a CRC of 36 g/g in 0.9% sodium chloride solution, an AUL (0.5 psi) of 25 g/g and having distinctly more than 2% by weight of particles >200 tm in size

Testing of Water Retention in Standard Mortar

A standard mortar prepared in accordance with EN 196 Part 1 was divided into five portions before mixing with water. Each portion was carefully mixed with 0.5% by weight of the two inventive SAPs 1 and 2 and of the comparative SAP 3*. The two other samples were left unmodified. All 5 mixtures were then mixed with the water quantities reported in the table which follows. The compressive and flexural tensile strengths of the mortars were determined in accordance with DIN 1164 at various times and under various conditions of aging.

The mixture containing the comparative SAP did not have a uniform structure after hardening. The defects due to the large SAP particles were visible to the naked eye. It was therefore impossible to determine the compressive and flexural tensile strengths.

TABLE 1
Compressive and flexural tensile strengths of
Inventive Examples 2 and 4 and Comparative
Examples 1 and 3

| | | | | | | | Flexural | | | |
|---|---|---|---|---|---|---|---|---|---|---|
| | | | Compressive strength | | | | tensile strength | | | |
| | | | 1d | 7d | 28d | 28d | 1d | 7d | 28d | 28d |
| Ex. | Addition | W/C | dry | dry | dry | wet | dry | dry | dry | wet |
| comp | none | 0.5 | 17 | 29 | 30 | 46 | 3.9 | 5.2 | 6.3 | 8.1 |
| 1 | | | | | | | | | | |
| inv 2 | 0.5% of | 0.5 | 20 | 35 | 38 | 48 | 4.4 | 6.0 | 8.4 | 8.0 |
| | SAP 1 | | | | | | | | | |
| comp | none | 0.58 | 13 | 23 | 22 | 38 | 3.3 | 4.7 | 5.0 | 7.7 |
| 3 | | | | | | | | | | |
| inv 4 | 0.5% of | 0.58 | 15 | 26 | 28 | 38 | 4.0 | 4.9 | 6.5 | 7.6 |
| | SAP 2 | | | | | | | | | |

| | | | |
|---|---|---|---|
| comp | 0.5% of | 0.58 | not determinable |
| 5 | comp | | |
| | SAP 3* | | |

The tests show that, compared with the respective control value, the addition of the inventive SAPs 1 and 2 raised the compressive and flexural tensile strengths of the standard mortars distinctly after 1 day (d) of dry aging but especially after 28 d of dry aging. This effect is clearly attributable to the water-storing effect of the SAPs, since the corresponding final strengths after wet aging are virtually identical with and without modification.

We claim:

1. Mixtures of finely divided solid hydrogel-forming polymers and of hydraulically setting building materials, wherein not more than 2% by weight of said finely divided hydrogel-forming polymers are more than 200 μm in particle size.

2. Mixtures as claimed in claim 1, wherein said hydrogel-forming polymers are used in such an amount that their fraction is from 0.01 to 5% by weight of said hydraulically setting building material.

3. Mixtures as claimed in claim 1, wherein said finely divided solid hydrogel-forming polymers are crosslinked polymers having acid groups.

4. Mixtures as claimed in claim 3, wherein said finely divided solid hydrogel-forming polymers contain units derived from monoethylenically unsaturated C₃- to C₂₅-carboxylic acid or anhydride monomer.

5. Mixtures as claimed in claim 4, wherein said finely divided solid hydrogel-forming polymers contain units derived from acrylic acid monomer.

6. A process for preparing mixtures as claimed in claim 1 by mixing said finely divided solid hydrogel-forming polymers with said hydraulically setting building materials, which comprises adding said finely divided solid hydrogel-forming polymers to the pulverulent building material prior to mixing with water.

7. A use as claimed in claim 1, wherein said hydraulically setting building material is cement.

8. The use as claimed in claim 1, wherein said hydraulically setting building material is gypsum.
